(19) United States
(12) Patent Application Publication
(10) Pub. No.: US 2005/0089054 A1
(43) Pub. Date: Apr. 28, 2005

(54) Methods and apparatus for provisioning connection oriented, quality of service capabilities and services

(76) Inventors: Gene Ciancaglini, Dover, NH (US); Muriel Medard, Cambridge, MA (US); John D. Moores, Groton, MA (US); Mark R. Parquette, East Kingston, NH (US); Donald P. Proulx, Dover, NH (US)

Correspondence Address: NETWORK APPLIANCE/BLAKELY, 12400 WILSHIRE BLVD, SEVENTH FLOOR, LOS ANGELES, CA, 90025-1030, US

(21) Appl. No.: 10/915,106

(22) Filed: Aug. 10, 2004

Related U.S. Application Data
(60) Provisional application No. 60/494,535, filed on Aug. 12, 2003.
(60) Provisional application No. 60/494,190, filed on Aug. 11, 2003.

(51) Int. Cl. H04L 12/56

(52) U.S. Cl. 370/412

(57) ABSTRACT

The present invention describes a system for providing quality of service (QoS) features in communications switching devices and routers. The QoS provided by this system need not be intrinsic to the communication protocols being transported through the network. Preferred embodiments also generate statistics with the granularity of the QoS. The system can be implemented in a single application-specific integrated circuit (ASIC), in a chassis-based switch or router, or in a more general distributed architecture. The system architecture is a virtual output queued (VOQed) crossbar. The administrator establishes policies for port pairs within the switch, and optionally with finer granularity. Frames are directed to unique VOQs based on both policy and protocol criteria. Policies are implemented by means of a scheduling engine that allocates time slices (minimum units of crossbar access).

### CROSS-REFERENCE TO RELATED APPLICATIONS

The present application claims the benefit of U.S. Provisional Patent Application No. 60/494,535, filed on Aug. 12, 2003 and U.S. Provisional Patent Application No. 60/494,190, filed on Aug. 11, 2003, both of which are incorporated herein by reference.

### STATEMENTS REGARDING FEDERALLY SPONSORED RESEARCH

Not applicable.

### FIELD OF THE INVENTION

The present invention relates generally to data and communications networking. In particular, it relates to providing quality of service capabilities and services in networks.

### BACKGROUND OF THE INVENTION

As is known in the art, Quality of Service (QoS) is a general heading that can include any of several different features in a network. One such feature is to provide a guarantee of a minimum allocated bandwidth through a network for a call or set of calls. A call is defined as communication from one end node to another end node. A call may consist of one or more connections, where a connection is communication from the ingress of one port within a switching device to the egress of a port, within the same switching device. A “flow” is defined as a one distinguishable communication flow from one end node to another end node. A call consists of one or more flows. For example, two end nodes may be communicating according to two different applications, e.g. a database transaction application and a data replication application. The two end nodes have one established call in each direction, and each call consists of two distinguishable flows. The terms “call,” “connection,” and “flow” typically imply connection-oriented service, where resources are dedicated for periods of time to the communication between the two communicating entities, but in the description of the present invention, the terms are used more broadly, without requiring connection-orientation. Another QoS feature is to provide a maximum bandwidth that may be used by a call or a set of calls. Yet another QoS feature is policing, whereby a switch, router, or other network appliance ensures that the service level agreement (SLA) for each call is not violated by the sources, and the term “policing” usually refers to dropping frames in order to maintain SLAs. Flow control mechanisms may play a role in SLA maintenance. QoS may also include guarantees that the latency for frames will not exceed a threshold. QoS may also include isochrony guarantees, meaning that frames can be expected to arrive at the destination at regular (to within some tolerance) intervals, at least if the frames are transmitted by the source at regular intervals.

End users often prefer absolute QoS guarantees to statistical guarantees. For example, an end user may prefer to be ensured that a call will always be granted a certain minimum bandwidth or more, rather than being guaranteed that the call will be granted at least the desired minimum bandwidth 95% of the time that the switch is operational.

Queuing and scheduling are important for enabling QoS. Some systems funnel all incoming frames into a single first-in first-out (FIFO) queue at each egress, but this can result in blocking, if the frame at the head of a FIFO queue cannot be serviced right away.

Output queuing is often considered the ideal model for switching, and is used as a reference for performance of other methods. With output queuing, each frame is immediately forwarded from the ingress port to the appropriate output port. Each output port must have sufficient bandwidth to handle frames being simultaneously forwarded from multiple ingress ports. The output port must also have sufficient buffering and/or adequate flow control to handle offered loads greater than unity. Switches designed to switch high-speed traffic typically cannot be practically or cost-effectively developed using output queuing because of the memory bandwidth requirements at the egress ports. A popular alternative is virtual output queuing. Each ingress has a set of virtual output queues (VOQs). As frames come into the ingress, they are classified, or inspected and fed into the appropriate VOQ. A VOQ might be assigned to each egress. Or, for finer granularity QoS, multiple VOQs could be assigned to each egress to further differentiate traffic flows. The switching fabric internal to the switch can be scheduled at regular intervals to define a set of non-conflicting ingress-egress pairs, enabling frames to move from ingress to egress. The scheduling can be used to ensure that the rate of frame transmission to the egress does not exceed the nominal capacity of the egress. Feedback from the egresses can be used to improve scheduling further, enabling adaptation to time-varying egress capacity. Feedback from the VOQs can also be used for improved scheduling. For example, empty VOQs need not be serviced, and in some cases it is preferable to service queues with preference based on VOQ occupancies or latencies. Scheduling algorithms for switch fabrics have many variants, but to the inventors' knowledge, no commercially available switches can provide QoS in Fibre Channel networks, nor to provide absolute QoS guarantees in other networks other than SONET/SDH and ATM networks.

If an ingress has multiple queues per egress, a queuing discipline (scheduling at the ingress port, rather than general scheduling of the entire internal switch fabric as described above) may also be needed in order to select from which queue the ingress should send to the egress at a particular time. Much of the literature and many commercial products use priority schemes, which cannot provide scalable absolute QoS guarantees.

Define a time slice to be the minimum time interval that is scheduled through the switch fabric. In most fabrics, time is divided into equal duration time slices, and each fabric port is in synchronization with all others in the sense that if the scheduler had assigned a connection from a first port to a second port for one time slice, the scheduler need not be concerned about timing if it chooses to schedule the next time slice from the first port to a third port, and from a fourth port to the second port. The scheduler does not have to keep track of state information to avoid temporal collisions based on uneven or unsynchronized time slices.

Some known scheduling/arbitration algorithms, such as iSLIP, that attempt to perform matching at high speed, operate every time slice. That is, an independent decision is made each time slice as to which ingress-egress pairs will be matched through the switching fabric. Such approaches typically have such optimization objectives as aggregate throughput maximization, but they typically do not attempt to maintain SLAs such as bandwidth guarantees, latency bounds, or jitter bounds.

Fibre Channel (FC) has been standardized by the American National Standards Institute (ANSI). FC is defined by Technical Committee Ti 1, the committee within the InterNational Committee for Information Technology Standards (INCITS) responsible for device level interfaces. INCITS is accredited by, and operates under rules approved by the American National Standards Institute (ANSI). FC is a serial data transfer architecture that has been widely adopted in storage area networks (SANs). FC is well suited to storage environments because of the efficiency and reliability with which it transports blocks of data suited to storage environments.

Within the FC architecture, three topologies are defined: point-to-point, arbitrated loop (FC_AL), and fabric. Point-to-point is simply a direct, dedicated link between two end nodes (N_Ports). Because there are no shared resources, no sophisticated queuing or scheduling is required.

FC_AL is a shared topology, where multiple devices are attached to a loop and each must arbitrate for access at a given time. FC_AL defines arbitration mechanisms and allows some flexibility. Some additional QoS could be overlaid on FC_AL. FC_AL is commonly used within large storage arrays.

The fabric topology is general, and supports switches that can interconnect multiple devices, with multiple flows sending frames at the same time. Fabric also supports meshes of switches. Because of its generality, most of the examples in the descriptions of the preferred embodiments of the present invention assume fabric topology. However, those skilled in the art will be able to apply some of the methods to FC_AL as well.

FC offers multiple classes of service. These include:
Class 1—connection-oriented, dedicated path
Class 2—acknowledged connectionless
Class 3—unacknowledged connectionless
Class 4—connection-oriented, fractional bandwidth, requiring hardware modifications.

Fibre Channel Class 1 service dedicates an entire path to one call in one direction. While this ensures that the call receives all of the resources available, it can be very inefficient not to share some of the bandwidth on a path with other calls. Thus, Class 1 is not often used.

Class 4 service is a more efficient alternative to Class 1, in that it enables dedicated fractional bandwidth service. Calls are guaranteed a fixed amount of bandwidth on each leg of the communication path from source to destination, and this bandwidth can be a fraction of, rather than the entire bandwidth of each segment. The drawback of Class 4 is that it requires changes to both the switch/router and host bus adapter (HBA) hardware. The industry has never adopted Class 4. Most FC users use Class 3 service (described below). Some use Class 2 service (described below). The unavailability of Class 4 HBAs and switches eliminated Class 4 from consideration for most customers. Although Class 4 would provide a solid infrastructure for QoS, it is not a practical starting point for a switch designer. Therefore, the description of the present invention focuses on the overlay of QoS onto Class 3 service. Those skilled in the art will be able to generalize the methods herein to other classes of service.

Class 3 service is in a sense the simplest: unacknowledged connectionless service. A transmitter transmits data basically whenever it wishes, as permitted by FC flow control, and without any feedback from the network or the receiver indicating the success of the transmission.

Class 2 service is similar to Class 3 in being connectionless, but Class 2 is an acknowledged service. That is, the recipient sends small messages back to the transmitter indicating the success of the receipt of data frames, so as to improve reliability.

While FC offers several different classes of service, there are users who would prefer more options for quality of service. In particular, there are customers who would use the fractional bandwidth capabilities of Class 4, e.g. if Class 4 hardware were commercially available or if the use of Class 4 service did not require a major hardware replacement. Users have expressed a need to be able to allocate a minimum amount of bandwidth to a particular call, or to be able to enforce a maximum bandwidth to be used by a call or by a set of calls in Fibre Channel based networks. Frame drops (loss of frames) is generally included under the heading of “QoS” but Fibre Channel flow control was designed to avoid frame drops due to buffer overflow and most Fibre Channel network users will not tolerate frame drops. Other QoS parameters can include latency and variance or isochrony, which are important to certain applications, including some replication and video distribution applications.

Overprovisioning, which is network design ensuring that the nominal fabric bandwidth exceeds the anticipated sustained load, is common practice in Fibre Channel SAN design. Designers often assume that overprovisioning will increase the probability that applications will receive the bandwidth required. However, typical deployments involve “many-to-one” scenarios, where multiple hosts or servers send or receive data to or from a single storage port. Having excess switch bandwidth may not offer any benefits because congestion at the storage ports (and attached switch ports) cause performance problems. A switch that can maintain SLAs under congestion may be more useful effective, and may be less costly than overprovisioning.

Fibre Channel uses a flow control mechanism whereby a device port sends “buffer-to-buffer credits” by means of R_RDY primitive sequences to the port at the other end of the link. If a device port has ingress buffer space adequate to hold M maximum-length FC frames, then that device will send up to M R_RDYs to the attached device. For each R_RDY received by the attached device, it is permitted to send a frame. The attached device counts outstanding R_RDYs, and if the number drops to zero, the attached device must stop sending frames to the port until more R_RDYs are sent by that port.

Ethernet is another standard used for networking. Ethernet is ubiquitous in local area network (LAN) environments, and there are efforts in standards bodies and in the commercial realm to grow the sphere of influence of Ethernet to metropolitan, access, and storage area networks. The widespread internet protocol (IP) is typically delivered using Ethernet. In the SAN arena, iSCSI is an emerging protocol that utilizes both IP and Ethernet. A switch that can pass Ethernet traffic can also pass iSCSI traffic, but generally cannot provide the protocol translation for stripping off the Ethernet, IP, and iSCSI headers to interface directly to a SCSI device. Ethernet does not provide QoS intrinsically. The methods taught herein enable QoS on an Ethernet network.

Although Ethernet does not specify a flow control that is exactly analogous to Fibre Channel buffer-to-buffer credit mechanism, the PAUSE frame mechanism bears significant similarities and can be used in a similar manner to avoid buffer overruns.

### BRIEF DESCRIPTION OF PRIOR ART

The Fibre Channel standard does not define a mechanism to provide connection-oriented fractional bandwidth service, or a variety of other connection-oriented services, using only hardware components (switches, routers, and HBAs) that are compatible with Class 2 and Class 3 service but not with Class 4 service.

There have been attempts to provide QoS in Ethernet-based networks using the Internet Protocol (IP). An example is Differentiated Services (DiffServ), which provides priority levels for different frames, but does not establish true connections, nor true bandwidth guarantees in general, and certainly not isochrony guarantees. A prior IP development, Integrated Services (IntServ) has better QoS capabilities than DiffServ, but was found not to scale well to internet-scale networks and has not been widely adopted. Such massive scalability is not required for most SAN deployments, and therefore IntServ-like features may be better suited to SAN environments. Recent efforts to merge features from DiffServ and MPLS-TE may also provide attractive IP QoS alternatives. The methods described herein provide other alternatives.

Published U.S. Patent Application No. 20030189935, “Systems and methods for providing quality of service (QoS) in an environment that does not normally support QoS features,” has described a system with goals similar to the present invention. However, the implementation is distinguishable from the present invention in several regards. The present invention is scalable to large switch designs, applicable to chassis-based switching devices and distributed switching systems, whereas the '935 published application disclosure applies to small scale switching devices. The present invention describes mechanisms for communication scheduling/arbitration information and queue feedback between centralized or distributed scheduling/arbitration engines and the ports. The present invention uses a different scheduling/arbitration mechanism. The present invention enables a switch administrator to define policies and policy groups for administering QoS and reporting statistics in convenient groupings.

### BRIEF SUMMARY OF THE INVENTION

The present invention includes methods and apparatus for a network switching device that can enable quality of service and fine-grained statistics even when the switch is switching traffic streams using a protocol that does not intrinsically provide the same degree of QoS. The QoS and statistics are provided as an overlay on the transport protocol. The preferred embodiments are scalable, being implementable in switching devices of small or large size, with few or many ports, with redundancy to whatever degree is desired. The switching devices may be chassis-based, with fixed or interchangeable line cards (printed circuit boards with input/output, I/O, ports) and/or switching cards and/or supervisory cards. The switching devices may use a single centralized scheduling/arbitration engine to control media access to the internal switching fabric, or the switching device may have a more distributed architecture, even to the point of having communicating elements that are not housed in the same chassis.

At a high level, the switching architecture is a virtual output queued (VOQed) crossbar architecture. The VOQs, at the ingress, and the output queues, at the egress, of each port on the switch may communicate with the scheduling/arbitration engine(s) out of band, i.e. not using the same communication paths as the network traffic, so as to not detract from the bandwidth available to the network traffic. The queue-to-scheduling/arbitration engine communication is feedback, whereby the scheduling/arbitration engine may make use of statistics describing the current status of the queues in making scheduling/arbitration decisions.

The VOQs can be pre-assigned to specific egresses, or dynamically assigned as needed. In a preferred embodiment, at each ingress, one VOQ is pre-assigned to each egress within the switching device, and additional VOQs may be assigned as needed. Additional VOQs are needed in order to differentiate flows that share a path from an ingress to an egress within the switching device. VOQs can be established manually by an administrator, or automatically by a classification engine at the ingress that searches certain fields in incoming frames to distinguish features such as destination address, source address, destination protocol port (e.g. TCP port), source protocol port, destination logical unit number (LUN), exchange number, VLAN tag, MPLS label, or any of a host of other possible fields. Maximum VOQ depths are defined, but the physical memory need not be dedicated to the particular VOQ until needed, which greatly improves the efficiency of ingress memory system utilization, reducing the total amount of ingress memory required in the design. In a preferred embodiment, the ingress memory system design intimately couples the Fibre Channel flow control buffer-to-buffer credit (BB credit) memory with this set of dynamic virtual output queues.

### BRIEF DESCRIPTION OF THE DRAWINGS

The foregoing features of this invention, as well as the invention itself, may be more fully understood from the following description of the drawings in which:

FIG. 1 is a general block diagram of a switching device comprising one or more switching fabrics and one or more line cards;

FIG. 2 is a depiction of one embodiment of the front panel of a chassis-based switching device with two switching/supervisory line cards and with twelve I/O line cards, each with 24 ports;

FIG. 3 is a block diagram of key elements of a preferred embodiment of the present invention;

FIG. 4 is a block diagram of a preferred embodiment of a Technology Interface Module (TIM), which is a daughter card that may be inserted into and removed from a line card. The particular TIM depicted has two ports; and

FIG. 5 depicts an encapsulation frame, used internally within a switching device or distributed switching device.

### DETAILED DESCRIPTION OF THE INVENTION

The present invention provides methods and apparatus to enable data network switches and routers to have the capability of complying with the Fibre Channel standard, interfacing with host bus adapters (HBAs) that are compliant with FC Classes 2 and 3 but not Class 4, yet which can provide connection-oriented service, including fractional bandwidth guarantees, variance guarantees, and other quality of service capabilities that are unavailable using traditional FC Class 2 and 3 services. Furthermore, QoS may be provided for other protocols such as Ethernet.

U.S. patent application Ser. No. ______, entitled NETWORK SWITCHING DEVICE INGRESS MEMORY SYSTEM, filed on even date herewith, and identified at Attorney Docket No. SAND-034AUS, is incorporated herein by reference.

The present invention includes creation of frame metadata describing the QoS parameters and possibly other parameters for each frame. This metadata may be incorporated into an encapsulation frame that encapsulates the incoming frames or portions of frames. The encapsulation frame is used internal to the switch only, or may be transmitted between multiple switches, but is stripped off the frames before sending the frames to HBAs or NICs (network interface cards) or switches or appliances that are not aware of this encapsulation scheme. In other embodiments, this frame metadata may be transmitted through an out of band (not in the data path) channel or in-band (in the data path) in separate cells or frames that are only passed to devices that understand the meaning of these messages.

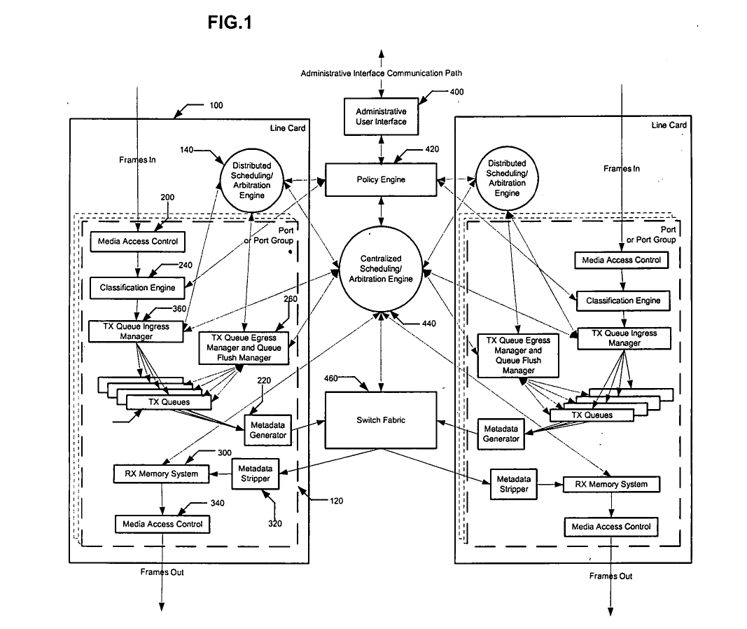

Subsystems within a switch or router that enable QoS include but are not limited to the following five subsystems: (1) mechanisms for queuing Fibre Channel (or other protocol) frames based upon such parameters as destination physical port, destination protocol (e.g. TCP) port, destination address, destination logical unit number (LUN), source physical port, source protocol (e.g. TCP) port, source address, source logical unit number (LUN) or a combination of any these or other attributes; (2) mechanisms for classifying Fibre Channel (or other protocol) frames and moving them into the appropriate queues; (3) methods for generating encapsulating frames or separate cells or frames that carry frame metadata that is used to maintain QoS, and methods for removal of said metadata, (4) scheduling and/or arbitration mechanisms, which may be centralized, distributed, or both, for servicing the queues and ensuring that QoS parameters are met, and (5) a policy engine with a user interface that allows the administrator to define service levels. These subsystems and others needed for one embodiment are depicted in a block diagram in FIG. 1, described in more detail below. Additional subsystems may include feedback mechanisms to or from the ingress or egress memory systems, e.g. for improving the adaptability of the scheduling or arbitration. Feedback from the egress memory systems is not explicitly depicted in FIG. 1, but is recommended in preferred embodiments.

Referring now to FIG. 1, the block diagram of FIG. 1 represents relevant components in a QoS-capable protocol-agnostic switch or router. Objects 400, 420, 440, 460 might reside as dedicated hardware in the switch or router, or could be placed on printed circuit boards (PCBs) or the like, as removable supervisory, switch, or combination supervisory/switching modules. Other objects in FIG. 1 are depicted as residing on line cards, which are typically removable modules housing PCBs. The switch or router might contain any number of supervisory, switching, supervisory/switching, or line cards. Each line card might support any number of ports. Ports are interfaces to devices external to the switch or router, such as computers (including but not limited to hosts, servers, or workstations), other switches or routers or network-attached storage heads which may or may not be QoS-aware, appliances (including but not limited to virtualization appliances, protocol gateways, protocol encapsulation appliances, security appliances, repeaters, regenerators, amplifiers, or media conversion appliances), sensors, controllers, test or measurement equipment, or storage devices (including but not limited to tape devices, tape arrays, optical media devices, optical media jukeboxes, disks, disk arrays, switched disk arrays, JBODs, RAID arrays, holographic memory systems, or solid state memory devices).

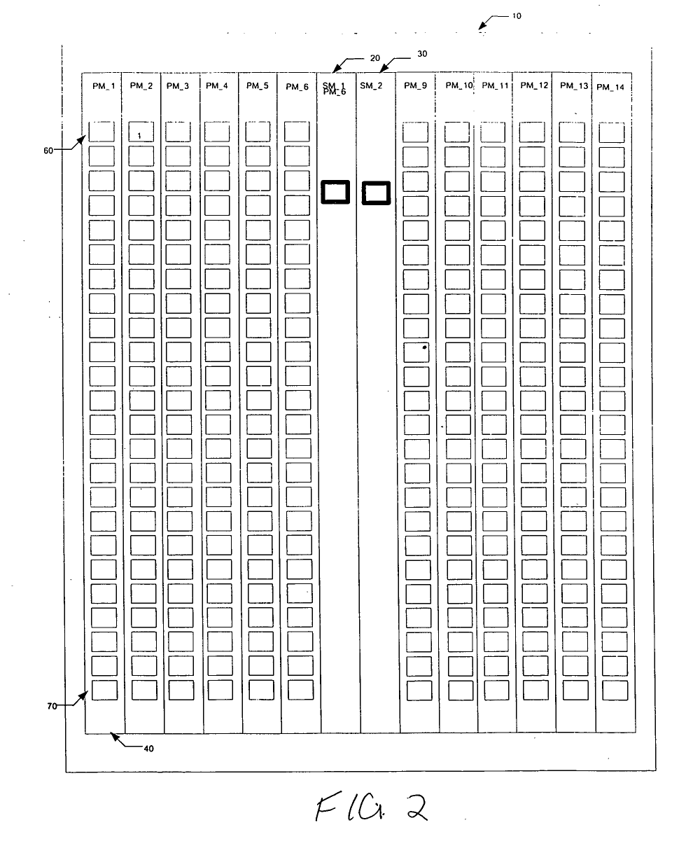

Referring now to FIG. 2, the physical switch/router could be housed in a chassis-style housing, that is roughly parallelepiped-shaped. FIG. 2 depicts a possible front view of such a chassis. The chassis, 10, can hold several cards, such as the line cards (PMs), 40, and the switching, supervisory, or switching/supervisory cards (SMs), 20 and 30. The line cards have several front-panel ports, 60, 70, for frames to enter and depart the switch/router. The SMs may have one or more front-panel ports for administrative access, not typically used for passing data frames.

Referring again to FIG. 1, the switch/router 90 is shown as having both a centralized scheduling/arbitration engine 440 and distributed scheduling/arbitration engines 140. In practice, either centralized or distributed scheduling/arbitration engines would be required, but it is not necessary for the switch or router to include both. The distributed engines are depicted as residing on each line card. However, switches could be designed with multiple distributed scheduling/arbitration engines on each line card, possibly one engine per port.

For simplicity and clarity of presentation, the switch/router 90 is shown with single points of failure. That is, if certain of the objects depicted in the figure were to fail in an operating switch or router, customer data traversing the switch/router could be compromised. However, those skilled in the art will be able to design redundant switches or routers based on the principles taught here, in order to provide superior network availability.

To clarify the roles of each of the components in FIG. 1, we describe the flow of control and data in the switch. This description will not include all of the functions and operations of the switch or router, but only a subset that clarifies the functions and operations relating to the provisioning of QoS.

An administrator for the switch communicates with the Administrative User Interface, 400, in order to establish QoS parameters and policies. For example, the administrator might establish that any data path communications from a first port to a second port on the switch/router will be guaranteed a certain minimum bandwidth, will not be permitted to exceed a certain maximum bandwidth, will or will not tolerate the intentional dropping of frames to preserve QoS, will be guaranteed some maximum latency, and will be guaranteed some specific degree of isochrony (variance). The administrator might have even finer granularity and be able to specify QoS attributes of different flows from the first port to the second port, for example based upon which software application is generating the data, or based on the global source and destination addresses (as opposed to the local switch ports) of the frames.

It is understood that QoS can include a variety of parameters and/or features, such as:
a) maximum bandwidth policy—where a call cannot be assigned more bandwidth than a specified maximum
b) if the minimum bandwidth policies for all calls to a specific egress do not equal the capacity of the egress (e.g., the nominal line rate of the communication path from the egress to the attached external device), then the excess bandwidth (the difference between the egress line rate and the sum of the minimum bandwidth policies to that egress) is distributed to all calls according to their needs, as determined via TX FB (transmit feedback).
c) when the egress is congested, meaning the RXMS is nearly full, as defined by specific high water marks in the RX queues, the excess bandwidth is distributed equally/fairly to each connection to that egress.
d) bounded jitter—where time slices are assigned to a connection as isochronously as possible
e) release of unused minimum bandwidth—if a connection has a minimum bandwidth policy, but from TX FB, the CCE (described below) recognizes that the connection is using substantially less than the minimum policy on average, the CCE can reallocate some of those time slices during the excess bandwidth phase of the scheduling algorithm. The guaranteed bandwidth phase of the algorithm will always reserve the minimum bandwidth policy's slices. This is important if new connections are trying to be initiated. Suppose the egress line rate is 200 MBps. Suppose I have a connection with a min BW of 120 MBps to that egress. There is also a connection with zero min BW to the same egress. Suppose the 120 min call is using only 30 MBps. The CCE might decide to allocate 60 MBps to that connection, releasing 60 MBps for the zero-min call to use. Now a new connection tries to get established with a min BW of 100 MBps. The CCE will recognize that even though it is only allocating 60 MBps to minimum bandwidth connections to that egress, it needs to reserve 120 MBps for the 120-min connection, and it will not allow the 100-min connection to be established. The 100 min call will be placed in a pending list until enough min BW becomes available, either by the 120 min call terminating, or the administrator changing the min BW policy of the 120 min connection to 100 MBps or less.

The administrative user interface, 400, communicates this information in a format usable by the Policy Engine, 420. The Policy Engine establishes, maintains, edits, and deletes QoS-related and other policies for connections through the switch. The Policy Engine, 420, communicates with the Scheduling/Arbitration Engine(s), 440 and/or 140, which in turn determine(s) which flows may access the switch fabric, 460, at which times and for how long. The switch fabric may be synchronous or asynchronous, and access to the switch fabric may be granted on a per-bit, byte, word, cell, frame, packet, time slice, or other time unit.

The flow of the user frames from the attached devices such as computers, storage devices or other devices is now described. These frames flow into a port on the switch/router. A media access control (MAC) device, 200, performs certain protocol-specific processing on the incoming frames. After passing through the MAC, the frames are processed by a Classification Engine, 240, which makes decisions as to which TX (transmit) virtual output queue, 280, associated with this ingress an incoming frame is to be routed. The TX Queue Ingress Manager, 360, assigns physical memory and updates tables and registers as described in detail below.

Each port has a set of TX virtual output queues, 280, used to differentiate connections/flows through the switch/router in accordance with the well-known virtual output queue (VOQ) model. An advantage of the use of multiple TX queues is that the scheduler/arbiter, 140, 440, can draw frames from different queues, 280, independently, whereas if a single TX FIFO (first-in, first-out) queue were used, frames would have to be serviced by the scheduler/arbiter in order, which would not permit QoS guarantees. If multiple TX queues, 280, are assigned to an individual port ingress, then the TX queues can be used to differentiate different local destination ports, different global source or destination addresses, different classes of service, different applications, etc. After a frame is placed in a TX queue, 280, it awaits servicing into the switch fabric, 460, as dictated by the scheduling/arbitration engine(s), 140, 440.

Frames in a VOQ need not be sent separately, but may be combined into one time slice, the fixed time increment used in the switching fabric, if the frames are f short enough duration. Furthermore, segmentation may be used to divide a frame so that a leading portion of the frame is transmitted in one time slice and a trailing portion of the frame is transmitted during a different time slice. If multiple frames or partial frames are combined into a single time slice, they may be separated by an interframe gap (IFG) or other separator. In a preferred embodiment, no IFG or separator is used between frames or partial frames because the reassembly function preceding the egress is able to distinguish the individual frames and partial frames and reinsert any IFG required by the communication protocol.

When a VOQ is to be serviced in the switching fabric during a particular time slice, the set of frames and/or partial frames to be transmitted during said time slice passes through the Metadata Generator, 220, before passing into the Switch Fabric, 460. The number of VOQs can be in the order of 80,000, for example.

The Metadata Generator generates an encapsulating frame around the incoming set of frames and/or partial frames, or appends a header or trailer or inserts a shim into the incoming frame, or generates a separate frame or cell to be sent in-band or out-of-band, or performs any combination of these functions. The purpose of this metadata is for use within the switch/router for ensuring QoS. The metadata might include fields such as global source address, local source port ID, source queue ID, global destination address, local destination port ID, destination queue ID, underlying protocol ID, application ID, flow ID, frame drop classification, or priority.

In a preferred embodiment, the Metadata Generator, 220, generates an encapsulation frame, surrounding the set of frames and/or partial frames to be sent during a time slice. The encapsulation frame can be used to carry protocol frames through a switching fabric. Internal frame encapsulation can be used to seamlessly support multiple protocols without the need for protocol conversion, and to enhance quality of service (QoS). The encapsulated frames can be scheduled into synchronous, fixed duration time slices for efficient switching and for managing quality of service.

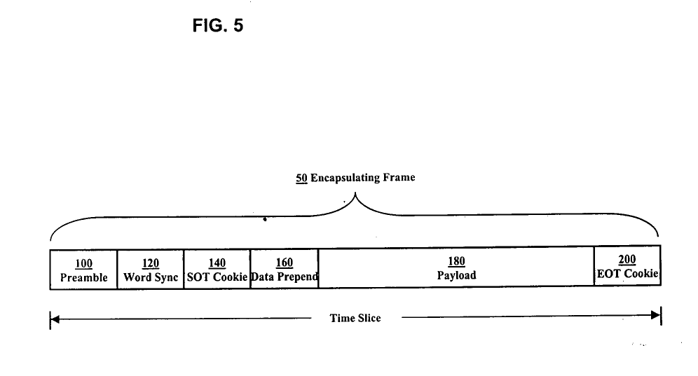

Referring now to FIG. 5, a preferred embodiment of an encapsulating frame, 50, generated by a Metadata Generator, 220, is depicted. Frames and/or partial frames stored in a VOQ to be transferred in a time slice are inserted into the Payload field, 180, and encapsulated by fields 100, 120, 140, 160, and 200. Field 100 is a Preamble, or bit synchronization pattern, used to re-align destination node's Clock Recovery Unit (CRU), following a period of frequency and phase discontinuity seen at an egress, e.g. when the crossbar switches a different ingress to send to said egress. Field 120 is a Word Sync, or word alignment pattern containing “Commas” used to facilitate transmission word alignment, where a word is a 4-byte sequence. In a preferred embodiment, the Word Sync pattern consists of four/BC/50 patterns (12 Idles). Field 140 is a Start-of-Transfer (SOT) Cookie. In a preferred embodiment, the SOT Cookie is a unique 8-byte data pattern used to identify the valid start of a Transfer of an encapsulating frame in a time slice. In a preferred embodiment, the SOT Cookie Pattern is: xAAAA_FFFF_{—}0000_{—}5555. One benefit of using a SOT Cookie is that transceiver noise can randomly generate valid SOF (start-of-frame) delimiters defined by the communication protocol, e.g. Fibre Channel, and the SOT Cookie reduces the probability of an egress misinterpreting time slice or frame boundaries. Longer SOT Cookies offer greater protection. Field 160 is the Data Prepend, which contains information such as source and destination address, or other identifying information about the call, flow, or connection. In a preferred embodiment, the data prepend is four bytes in length and comprises a two-byte source address concatenated to a two-byte destination address. Field 200 is the End-of-Transfer (EOT) Cookie. This field is useful for delineating time slices, marking the termination of the transfer in one time slice. This delineation is useful when segmentation and reassembly are used, and a partial frame is at the tail of the payload field, 180. In a preferred embodiment, the EOT Cookie consists of two concatenated K28.5 comma characters.

In a preferred embodiment, each of the fields in the encapsulating frame, 50, is programmable. In a preferred embodiment, the duration of a time slice is equal to the duration of an encapsulating frame that can carry a maximum-length frame of the communication protocol, e.g. a 2148B Fibre Channel frame, in the Payload, 180, field of the encapsulating frame.

Referring again to FIG. 1, after passing through the Switch Fabric, 460, encapsulation frames travel on to the local destination port, 120, where the metadata is stripped off in the Metadata Stripper, 320, and the frame is fed into that port's RX memory system, 300. The RX memory system, 300, could be as simple as a FIFO with rate matching, or could be partitioned into e.g. per flow or per source port regions. The metadata is removed from the frame in the Metadata Removal unit, 320, if the device attached to the port is not aware of the QoS mechanisms used in this switch. The metadata may or may not be removed if the attached device is aware of these QoS mechanisms. The frame then passes through a MAC, 340, and on to the attached device.

In the preceding, the flow of protocol frames through the switch/routing device was described. There are additional functions. The TX Queue Ingress Manager, 360, allocates physical memory and updates registers, tables, and counters as frames are added to the TX memory system. The TX Queue Egress Manager and Queue Flush Manager, 260, perform two sets of functions. The TX Queue Egress Manager deallocates physical memory and updates registers, tables, and counters as frames are removed from the TX memory system. The Queue Flush Manager deletes the contents of a VOQ, deallocating the physical memory and updating registers, tables, and counters.

In an exemplary embodiment, the number of VOQs is about 80,000. The number of queue managers, receive memory systems, MACs, ports, feedback paths, control paths, metadata generators and strippers can range from about one or two to about 144.

Next, a preferred embodiment is described in detail. Features of the overall present invention will become clearer upon consideration of the preferred embodiment. Furthermore, it is to be understood that those skilled in the art will be able to make any of a large number of possible modifications to the preferred embodiment and still remain within the scope and purview of the present invention.

Exemplary Embodiment Architecture Detail

### Overview of Switching Architecture

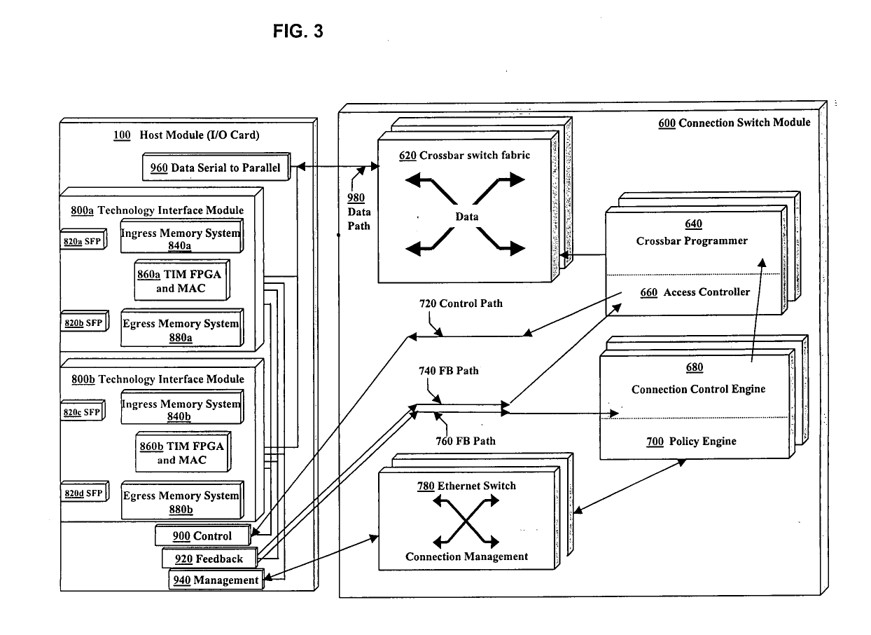

Referring now to FIG. 3, an exemplary switching device uses slotted time division multiplexing (TDM) in a virtual output queued (VOQ) scheduled crossbar switched architecture. A printed circuit board (PCB) that composes a switching and supervisory line card, or “blade,” the Connection Switch Module (CSM), 600, includes the crossbar switch, 620, the processor running the centralized Policy Engine, 680, and Connection Control Engine (CCE), 700, and an FPGA acting as the switch fabric access controller, 660, and crossbar programmer, 640. The CSM also comprises a switch, 780, for a connection management backplane. In a preferred embodiment, switch 780 is an Ethernet switch, and the connection management backplane is an Ethernet backplane.

An Administrator establishes policies, which in turn establish QoS parameters for SLAs, using an administrative interface. The Policy Engine, 700, maintains this policy information. The Policy Engine also receives feedback from the VOQs in the Ingress Memory Systems, 840a and 840b, of active ports in the switch, over the feedback path, 760. The CCE, 680, passes the relevant policy parameters, based upon administrative policy and feedback, to the CCE, 680, for use in computing schedules.

The CSM FPGA, whose functions are different from the Technology Interface Module (TIM) FPGAs, 860a and 860b, receives the first-round schedule, or assignment of ingress-egress pairs as a function of time, computed by the CCE, 680. The FPGA also monitors receive feedback (RX FB) from the RX memory systems associated with the egresses, 880a and 880b, arriving via feedback path 740, and in a preferred embodiment also monitors transmit feedback (TX FB) from the VOQs, 840a and 840b, arriving via feedback path 740. The TX FB received by the Policy Engine, 700, and the CSM FPGA may be different, and are different in a preferred embodiment, both in terms of the content of the feedback and the frequency with which the feedback is presented. The CSM FPGA receives very frequent updates of VOQ occupancy, preferably every time slice. The Policy Engine, 700, receives feedback related to recent bandwidth utilization by VOQs, but this may be averaged or summed over multiple time slices. The CSM FPGA programs the crossbar switch based upon the current first-round schedule computed by the CCE, 680, modified by the RX FB and TX FB.

The CCE, 680, computes a schedule over an epoch, which is a contiguous block of time slices, of at least one time slice, possibly hundreds of time slices. Computing schedules over epochs longer than a single time slice, rather than every time slice, is valuable for scheduling for QoS, such as ensuring minimum bandwidth guarantees with fine bandwidth granularity or for minimizing jitter in order to meet isochrony requirements. Time slices can be scheduled at regular intervals over the epoch. However, for optimal switch performance, it is also valuable for the crossbar programmer be capable of responding on a per time slice time scale to events such as a VOQ becoming empty, a VOQ becoming congested or filled, or an egress memory system filling, or becoming congested.

Each CSM has some internal redundancy for enhanced availability, and a chassis can support redundant CSMs with rapid fail-over, for even higher availability. For even greater availability, two redundant preferred embodiment switches, with identical hardware and software, can operate as an active/active pair, where if one switch has a failure, the other switch can immediately take over the switching of the data streams.

In other embodiments, any or all of the functions performed by the CSM may be performed by one or more application-specific integrated circuits (ASICs) or general-purpose processors.

In addition to the CSM(s), the chassis also houses Host Modules, 100, also known as input/output (I/O) access blades, I/O Modules, I/O cards, or simply as line cards. Many variants of the Host Modules are possible. The preferred embodiment houses daughter cards, known as technology interface modules (TIMs) that slide into and out of the host modules, providing two-port granularity. The Host Module can support up to 6 TIMs. Host Modules can be implemented with or without TIM daughter cards, but TIMs are attractive to many customers for reducing inventory costs, reduced impact on the system if a port were to fail, the potential to incorporate new technologies on a small scale with smaller incremental cost, e.g. to purchase a TIM with a higher bandwidth where the customer only needs a few ports at the higher bandwidth.

On board the Host Module, 100, are subsystems including a Serial-to-parallel conversion function, 960, interfacing to the high-speed data backplane, 980, whereby ports communicate protocol frames with the CSM switching fabric(s), 620, and with each other.

The Host Module hosts a Control subsystem, 900. The CSM FPGA regularly communicates to each Host Module over a Control path, 720, using schedule allocation messages (SAMs) that specify which VOQs are permitted to transmit during a given time slice. The Control subsystem, 900, feeds the relevant SAM information to each TIM, 800a or 800b. In a preferred embodiment, the Control path, 720 is a dedicated Ethernet path.

The Host Module houses a Feedback subsystem, 920. This subsystem gathers statistics from the TIM FPGAs, 860a ad 860b, preprocesses this data, and passes it to the CSMs via Feedback paths 740 and 760. In a preferred embodiment, Feedback subsystem 920 includes a Host Module FPGA, distinct from the TIM FPGAs, 860a and 860b and distinct from the CSM FPGA. This Host Module FPGA performs preprocessing of statistics. In other embodiments, any or all of the Host Module Feedback subsystem functions are performed by a general-purpose processor or by an application specific integrated circuit (ASIC).

The Host Module, 100, hosts a Management subsystem, 940, which performs a variety of management functions, including sending and receiving management information over the Connection Management backplane. Other management traffic includes information relating to Fibre Channel services, policy, connection status, and image download.

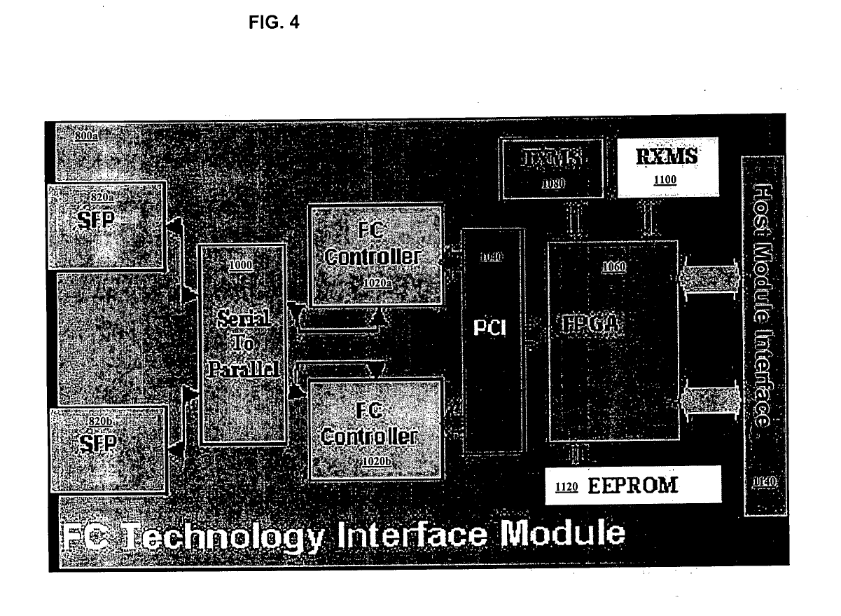

Although the TIMs, 800a and 800b, are depicted at a high level in FIG. 3, they are described in detail in the description of FIG. 4 below.

Referring now to FIG. 4, a preferred embodiment of a two-port TIM, 800a, is depicted at a block level. In the figure, at the left side are the two ports, to which network cables may be attached. The depicted blocks 820a and 820b, represent small form factor pluggable (SFP) transceivers. Bit streams coming in from the network or from attached end node devices pass through the SFPs, 820a and 820b, and pass to the serial-to-parallel converter, 1000. This component is necessary if the SFPs are providing serial streams, but the Fibre Channel (FC) Controllers, 1020a and 1020b, require parallel streams as inputs. The FC controllers perform the functions required by the Fibre Channel specification. Frames then pass from the FC controllers to a field-programmable gate array (FPGA), 1060, over a bus. In the preferred embodiment depicted, this bus is a PCI bus, 1040. Those skilled in the art will appreciate that there are many alternative bus technologies that could be used instead of PCI, still within the scope and purview of the present invention. The FPGA, 1060, performs many different functions, including aspects of the Classification Engine function, TX Queue Ingress Manager function, TX Queue Egress Manager function, Queue Flush Manager function, Metadata Generator function, Metadata Stripper function, statistics gathering and propagation, search engine function, interface to external search engine device(s) (not depicted), interface to an EEPROM, 1120, interface to the transmit (ingress) memory system (TXMS), 1080, interface to the receive (egress) memory system (RXMS), 1100, and interface to the Host Module Interface, 1140. Protocol frames pass from the FC Controllers, 1020a and 1020b, across the PCI bus, 1040, and into the FPGA, 1060. From the FPGA, frames are passed into the TXMS, 1080, where they are stored temporarily in VOQs. Frames are eventually retrieved from the TXMS, 1080, pass back through the FPGA, 1060, and on to the Host Module Interface, 1140, where they pass to the Host Module, en route to the switching fabric(s) on the CSM(s).

In the other direction, when frames are delivered from the switching fabric on the master CSM to the TIM, 800a, they enter through the Host Module Interface, 1140. Frames are placed into the receive (egress) memory system, RXMS, 1100. When the appropriate FC controller associated with the destination port is able to receive an additional frame, a frame is taken from the RXMS, 1100, passes through the FPGA, 1060, through the PCI bus, 1040, and on to the appropriate FC Controller, which without loss of generality is assumed to be 1020a. After processing according to the Fibre Channel standard, the frame passes from the FC Controller, 1020a to the Serial to Parallel Converter, 1000, where the parallel stream is converted to a serial stream. This stream is passed into the SFP, 820a, and transmitted out the associated port and onto the attached cable, for transmission to the attached end node device or network.

Devices such as servers and storage arrays are connected via Fibre Channel (FC) cabling to TIM ports on SAN host modules. The Policy Engine and Connection Control Engine set up shared virtual circuits through the internal crossbar switch fabric between pairs of ports (unicast) or groups of ports (mirroring). The Policy Engine ensures that each connection setup request does not violate FC zoning or preferred embodiment policy for QoS established by the network administrator.

Incoming frames to a TIM port from the network (ingress, or TX side) are classified by their destination identifier (DID) and traffic type, Fibre Channel or Gigabit Ethernet, and fed into VOQs in the “transmit memory system” (TXMS) for that port. Each technology interface module (TIM) or port has its own TX and RX memory systems, so that a failure of one memory system affects only one TIM, rather than the entire switch as might happen in a shared memory architecture. The preferred embodiment uses segmentation and reassembly (SAR), and is capable of efficiently packing many smaller frames into a single time slice.

Some switch/router architectures offer multiple paths through the internal switch fabric. The preferred embodiment uses a single path through a single centralized crosspoint switch. However, those skilled in the art could design switches/routers in the spirit of the present invention using multiple paths through multiple switching fabrics. Multiple paths require redundant CSMs, multiple switching fabrics per CSM, switching fabrics on the line cards, or redundant chassis.

Resident on each CSM is the processor that runs the Policy Engine and Connection Control Engine, and the FPGA-based schedule dispatcher, which also serves to program the cross-point switch at the precise instants called for by the Connection Control Engine.

The Policy Engine enables the establishment of QoS parameters for connections between ports, and manages call admission. The Connection Control Engine rapidly assigns time slots to connections, consistent with the established policies and the physical layer capabilities of the devices attached to the ports. Preferred embodiment policies enable an administrator to specify QoS for Fibre Channel (FC) Class 2 and Class 3 traffic, which would be impossible with any other FC switch on the market today.

### Chassis Independence

Each chassis runs its own independent Connection Control Engine. If a chassis houses more than one CSM, the Connection Control Engines on the two CSMs run the same scheduling algorithms and generate the same schedules, to ensure rapid failover with minimal data loss. Currently there is no signaling between chassis for establishing virtual circuits through a fabric of switches. Establishment of VCs through a fabric would currently be handled through the setting of discrete policies on each switch.

Only inter-switch links (ISLs) are needed for interconnecting Preferred embodiment chassis. This means that normal Fibre cabling can be used and that no extra cabling is required for signaling or other functions. Between preferred embodiment chassis, multiple ISLs can be automatically combined together in a trunk group. Future designs may introduce inter-chassis signaling and call setup, providing policed end-to-end QoS across multiple chassis.

### Connection Orientation

A connection is a virtual circuit internal to a Preferred embodiment switch, between ingress port (“TX”) and egress port (“RX”). The noun “call” is often used synonymously with “connection.” In the future, finer connection granularity may be offered, so that multiple connections, possibly with different policies, might exist between two ports. Methods under consideration include SCSI logical unit number (LUN) and/or source identifier (S_ID).

### Policy, Policy Groups, and Policy Parameters

In Preferred embodiment terminology, a policy defines a set of QoS parameters for a unidirectional connection. Policies are established between ports (ingress and egress ports), or defined between groups of ports (policy groups) through the Preferred embodiment switch. The specific QoS parameters are described below.

Each port is assigned to a policy group. By default, at time of initialization, each port is assigned to the policy group named “Community” for the OSI Reference Layer 2 protocol used by this port. Every port pair is subject to the same policy when it is in the same Policy Group. To establish particular policies, the network administrator may override the default policy group assignments. The administrator is at liberty to define as many policy groups as desired. For greatest control over individual connections, each port could be assigned to its own policy group.

As for the QoS parameters of policies, each call is assigned a minimum bandwidth and maximum bandwidth. Calls are also associated with a traffic type, which currently refers to the OSI Reference Layer 2 protocol, currently either Fibre Channel (FC) or Gigabit Ethernet (GbE). The default Community policy group specifies a minimum bandwidth of zero and a maximum bandwidth of 200 MBps.

It is important to note that the data backplane has some fractional over-speed (a/k/a “speedup”), so the Connection Control Engine could potentially schedule more data backplane bandwidth to a connection than the source could provide. The backplane runs at 2.5 Gbaud with 8B/10B encoding, making the over-speed 17.647% (calculation for percentage=(2.5-2.125)/2.125*100%) relative to a dual-speed FC stream (2.125 Gbaud) per TIM or per cross-point port.

Best practice is that ports participating in connections/calls requiring QoS be assigned to administrator-defined policy groups, and ports that do not require QoS can be left in the default Community policy group. This is best practice for performance. A benefit to the use of administrator-defined policies for every port is granularity and the ability for an added layer of security. Security from policy is that an administrator can assign zero bandwidth for calls, somewhat analogous to FC hard zoning.

### Call Admission

Unlike most data switches, the Preferred embodiment implements a media access control (MAC) algorithm to allow or disallow call setup. A port will request the setup of a connection, and the connection will be admitted only if the Connection Control Engine can admit this call without violating any of the policy requirements for existing calls and for the new call.

Furthermore, The preferred embodiment enables the prioritization of connections for the connection setup process, so that higher priority calls are more likely to be admitted than lower priority calls with similar policy requirements. Note that in common networking jargon, “priority” refers to preferential treatment for one active call over another, which is different from The preferred embodiment's prioritization of call setup. The preferred embodiment allows priority of calls before they are active, ensuring that the connections that are most important to the customer are considered first for activation, while still ensuring that policies are not violated.

When a link is connected (a device is physically connected to Fibre cable attached to a TIM port), the CSM is notified over the out-of-band Ethernet control backplane. The TIM port's connections are initially assigned to the Not Active state. The Connection Control Engine assigns time slices for full-duplex communications between that port and the supervisory engine on the CSM for those signaling, control, and management functions that are handled in-band across the data backplane. Certain other signaling, control, and management functions are handled out-of-band over the separate Ethernet management backplane, or over dedicated communication paths.

In the currently available firmware/software build, the Connection Control Engine also sets up full mesh connections from a port to all Active ports on the switch, and then that port is assigned to the active state. A VOQ on the TIM is statically assigned to each connection. If no data arrives into the VOQ within a timeout period, the connection becomes Not Active again.

Because the vast majority of connections in a SAN are bidirectional, the Preferred embodiment system will automatically set up not only the call as requested (unidirectional), but also the reverse direction call, which can cut the bidirectional connection setup time roughly in half. This automatic bidirectional call setup occurs even if the policy from source to target is different from the policy from target to source.

### Scheduling Discipline

Competitive Scheduling Landscape

Some presently available switches use disciplines such as round robin or weighted round robin (WRR) servicing of ingress (TX) queues, which provide the VOQs fair or biased access to the switch fabric. Currently some non-FC switches offer strict priority as well, where a port or sub-port may have several VOQs of different priority. The highest priority VOQs will always be serviced first, which can be especially valuable with delay-sensitive traffic. Standard implementations of round robin, WRR, and strict priority can be work-conserving, offering low average delay, but cannot provide true bandwidth guarantees.

Some modern arbitrated crossbar switches implement a request/grant exchange between VOQs and the switch fabric. This request/grant process is performed on a per frame basis, which requires rapid communication and considerable processing facilities. But these architectures typically use memoryless scheduling and require very simple algorithms, which can be far from optimal because they have to meet the stringent switching speed requirements despite the communication and processing overhead of the request/grant process. The preferred embodiment's minimum bandwidth guarantees are reliable and do not require any of this overhead. The preferred embodiment's excess bandwidth allocation responds less rapidly, but responds fast enough for most applications, and does not introduce the request/grant overhead, which some commercial switch fabrics implement in-band, taking away from data throughput. The preferred embodiment's TX and RX feedback, described below, used so that the scheduler is aware of the ingress and egress status, and out of band and do not detract from data throughput.

SONET/SDH and ATM switches offer true TDM scheduling for real-time traffic, offering the best delay, jitter, and throughput guarantees, but this feature is not available in storage switches today. SONET/SDH and ATM switches tend to be more costly and complex than storage switches. Typical TDM switches use pointer processors and special non-work conserving schedulers such as virtual clock schedulers, and are able to offer varying degrees of bandwidth granularity. Most typical TDM architectures only offer granularity down to STS-1 (51.84 Mbps). The preferred embodiment's user interface provides granularity to 1 MBps, but the underlying architecture can support even finer bandwidth granularity.

The Preferred Embodiment's Approach to Scheduling

The preferred embodiment's approach is more akin to a multi-protocol, multi-service edge switch than is typical of a data center switch. The preferred embodiment uses an inventive multiphase scheduling algorithm to meet all of the QoS parameters of each call. The preferred embodiment offers unparalleled bandwidth granularity of 0.5 MBps in the default configuration, although the current user interface specifies bandwidth to 1 MBps (=8 Mbps=10 Mbaud) granularity, which customers believe will meet their needs. The preferred embodiment provides a simple analog to a virtual clock scheduler for real-time traffic with true QoS requirements of minimum bandwidth or isochrony. The preferred embodiment provides excess bandwidth scheduling for the remaining traffic, using an algorithm similar to the iSLIP algorithm in the literature. A single centralized Connection Control Engine on each CSM performs the multiphase scheduling algorithm, described in more detail below.

### Network Feedback

For policy-based connections, e.g. those requiring minimum allocated bandwidth, the Connection Control Engine essentially statically allocates the required minimum bandwidth if it can do so without violating any bandwidth guarantees. These assignments change only as policies are modified or when distinguishable calls or flows are added or dropped, and do not involve checking the current status of the egress queues for congestion, nor checking the current status of each ingress VOQ for occupancy.

When allocating excess bandwidth, which includes any bandwidth in excess of the minimum bandwidth requirement of each active connection, the CCE can follow one of two allocation policies, namely fairness or rate-adaptation, as selected by the administrator. In fairness mode, excess bandwidth will be equally distributed to all connections, subject to maximum bandwidth limitations specified by connection policies. In rate-adaptation mode, the CCE uses feedback from the ingress (VOQs) to determine the current actual bandwidth need of each connection. If possible, the CCE allocates this bandwidth, and shares the excess amongst all connections, again subject to maximum bandwidth restrictions of bandwidth policy. The feedback is weighted averaged and the response to the feedback is on the order of several milliseconds. Thus rate-adaptation mode approximates min-max fairness, but does not respond instantaneously to every individual burst arriving at the ingress. If the egress becomes congested, rate-adaptation mode reverts to equal sharing, as in fairness mode.

An administrator might choose fairness mode in order to protect against denial of service attacks, or simply to ensure equal access for all connections. Rate adaptation mode is important for use in scenarios with asymmetric and time-varying workloads.

For an asymmetric example, suppose a storage device is connected to three servers. On average, the storage device needs to send data to server 1 at 100 MBps, but only sends 10 MBps on average to each of servers 2 and 3. In fairness mode, the connection to server 1 would be granted only 200 MBps/3, which would be insufficient to meet its requirements, yet the connections to servers 2 and 3 would be granted significantly more bandwidth than they require on average. In rate-adaptation mode, each connection would be granted the bandwidth it needs.

For a time-varying example, a storage device may be connected to multiple servers, and may be servicing asynchronous requests for large data transfers. Suppose three servers are connected to the storage device and the first requests several large blocks of data, while the other servers are not requesting any data. After the transfer to server I, server II requests several large blocks. Later server III requests several large blocks. In fairness mode, the storage device would allocate 200 MBps/3 to each connection from the storage device to each server, which could add considerable latency to each data transfer. In rate-adaptation mode, the CCE would initially allocate the most bandwidth to server I. Then when server I was no longer requesting data, the connection to server I would be allocated less bandwidth. When the connection to server II required bandwidth, the CCE would allocate more bandwidth to that connection, etc.

In this section, we have considered the static allocation of minimum bandwidth per connection as specified by bandwidth policy. We have also considered the two modes, fairness and rate-adaptation, for allocating excess bandwidth. Rate-adaptation mode takes advantage of feedback from the ingress VOQs (“transmit feedback,” or “TX feedback”). The preferred embodiment also makes use of feedback from the egress queues (receive feedback, or “RX feedback”). The preferred embodiment provides RX feedback to the schedule dispatcher, downstream of the Connection Control Engine. The dispatcher can disable certain transmitters on a per frame basis, with a response time on the order of ten microseconds. But the schedule dispatcher will never disable transmissions from the CSM to any port, to ensure that in-band signaling, control, and management functions will not be disrupted.

The preferred embodiment also incorporates powerful hardware-based “adaptive allocation” based upon current incoming traffic (VOQ fill levels). This enables more rapid TX feedback, to accommodate rapidly time-varying workloads, and also enables on-the-fly reallocation of statically assigned minimum bandwidth if the source VOQ is currently empty.

### Bandwidth Allocation and Adaptation

Policies are specified by minimum and maximum bandwidths. Unlike most data switches, which schedule on a per time slice basis, The preferred embodiment schedules an entire “epoch” at once. The default duration of the epoch is 4000 time slices, where each time slice can hold up to two 1060B frames (including overhead). The Connection Control Engine grants VOQs access to the internal switching fabric using a multistage algorithm.
QoS Phase: First, the Connection Control Engine will allocate the minimum bandwidths to all calls, while ensuring that each receive (RX) port (receiving frames from the internal switch fabric) is not overrun by receiving frames at a rate exceeding the nominal capabilities of its physical interface. Time slices are allocated in as evenly distributed a manner as possible. In future revisions, isochronous calls will be allocated first, in order to minimize variance. Then the remaining calls with minimum bandwidth requirements will be scheduled.
Excess Bandwidth Phase: Any excess bandwidth that an egress is capable of receiving is divided amongst the VOQs with active calls to that egress, up to the maximum bandwidths of the policies for these calls. The administrator has a choice of allocation policy: fairness mode or rate-adaptation mode. In fairness mode, excess bandwidth is divided equally amongst all VOQs sending to that egress. In rate-adaptation mode, min-max fairness is approximated: excess bandwidth is allocated based upon current need, with a response time of milliseconds, and under congestion rate-adaptation reverts to fairness.

The Connection Control Engine attempts to disperse the allocated time slices, distributing them through the epoch as evenly as possible. This dispersal improves utilization and reduces the probability of RX overflow.

As calls are added or dropped, and/or as policies change, the Connection Control Engine makes adaptations accordingly. The Connection Control Engine adaptability is immediate and will be reflected in no more than the computation time for two schedule updates.

In effect, the Connection Control Engine nearly emulates a FC Class 4 (shared or fractional virtual circuit) environment, which would otherwise require targets and initiators to be FC Class 4 aware. For most customers, achieving Class 4 awareness would require replacing all of their host bus adapters (HBAs) and switches. The preferred embodiment's proprietary Connection Control Engine enables the preferred embodiment to achieve behavior similar to FC Class 4 without changing the currently deployed HBAs. However, without the replacement of the HBAs, it is not possible to apply backpressure on a per VC basis between the HBAs and switches. Nonetheless, no other Fibre Channel switching platform enables this shared virtual circuit functionality for FC Class 2 and 3 traffic.

### Comment on Call Set Up Latency

The use of an epoch for scheduling has tremendous advantages in terms of QoS provisioning, bandwidth granularity, and capabilities of dispersal or even of providing isochronous service (bandwidth allocated at regular intervals). A drawback of the epoch-based approach is added latency to call activation and to changes in schedule based on call drops or policy changes. Policies will not be modified during an epoch, but must wait for the completion of the current epoch. Suppose a time slice were 10 μs, and an epoch were 500 slices, then the worst case latency based on the epoch would be 50 ms. However, the computation of a new schedule can be less than or greater than one epoch duration. Thus, the call setup latency can depend upon the current set of active calls in the switch. A more complex set of connections results in greater latency. This latency can exceed one second in a fully populated chassis with full mesh active connectivity.

### Connection Age-Out

If the VOQ for an active connection remains empty for greater then the The preferred embodiment age-out time, the call is classified as inactive. The default age-out time is 90 seconds, based upon the 60-second disk-polling interval used by the Microsoft Windows 2000 operating system.

### Connection Preemption

True preemption of active connections should not occur in SAN fabrics comprised of preferred embodiment switches. However, new call requests with nonzero minimum bandwidth requirements will reduce the allocated bandwidth to those calls that have nominal zero minimum bandwidth. In the special circumstance in which a new call request arrives such that the sum of the minimum bandwidths of the nonzero minimum bandwidth calls equals the bandwidth capability of the physical interface associated with the RX port, then the default calls will be allocated nominal (close to zero) bandwidth, and will therefore be effectively preempted. If a network administrator should accidentally set up connections in this manner, he or she will have ample feedback indicating the problem in the Policy Report Card.

### Inter-Switch Links and Trunking

From the Policy Engine and Connection Control Engine perspective, an inter-switch link (ISL), connecting two switches, is treated no differently than any other port. At the TX side of a TIM, multiple global destination IDs may be mapped to the same outbound ISL port on a line card, but this fact is irrelevant to the Connection Control Engine.

Trunking is more complicated. Trunking refers to the use of multiple ISLs between two preferred embodiment switches, such that flows between the switches are distributed across the ISLs in an intelligent manner. There are at least two approaches used in the industry for balancing the load on the ISLs in a trunk, using either per connection granularity or per frame granularity: (1) Per connection: upon call setup, each entire connection is mapped to a single ISL—typically the least loaded ISL at the time, but in general so as to distribute the load as evenly as possible across the ISLs, or (2) Per frame: the frames from each connection are distributed across multiple ISLs so as to most evenly balance the load across the ISLs. While the per frame approach is finer-grained and can most evenly divide the load amongst the ISLs, it requires complex frame reordering hardware on the destination switch. The preferred embodiment uses the per connection approach, which is simpler, requires less hardware, and still meets customer needs. The simplicity of the Preferred embodiment approach could lead to simpler interoperability in future standards.

### End-To-End Quality of Service

Because of the nature of The preferred embodiment queuing and scheduling, end-to-end QoS through a fabric of multiple Preferred embodiment switches is not currently available, in the strictest sense of the term and for the most general mesh of connections. True end-to-end QoS would enable virtual circuit setup throughout the fabric, would establish consistent policies across the fabric, and would provide a policing function at each switch on the basis of the end-to-end connection rather than the intra-switch port-to-port connection. Recall that a “connection” in Preferred embodiment parlance refers to a virtual circuit between two ports on the same chassis. “End-to-end connection” refers to a virtual circuit between an initiator attached to one Preferred embodiment switch and a target attached to another Preferred embodiment switch. It is certainly possible for a network administrator to set policies consistent with an end-to-end VC, and if each Connection Control Engine accepts the associated connection requests, a VC is established. If the end-to-end connection is using dedicated paths between each port and dedicated ISLs, then end-to-end QoS should be maintained. However, because Preferred embodiment queuing is on a per port basis, various cross-fabric connections will often be aggregated across some physical link or intra-switch connection. The Connection Control Engines are unable to police the individual end-to-end connections that make up an aggregated intra-switch port-to-port connection. If the sources are well-behaved and transmit within their QoS policy bandwidth bounds, end-to-end QoS will be achieved.

Summarizing, The preferred embodiment does not guarantee strict end-to-end QoS though a multiple switch fabric of Preferred embodiment switches for arbitrary configurations. However, in a properly engineered network, end-to-end QoS is achievable through a Preferred embodiment multi-switch fabric.

### Note on Frame Dropping Vs. Backpressure

Technically, Frame Dropping vs. Backpressure is a queuing issue rather than a scheduling/policy issue. The preferred embodiment does not permit frames to be dropped under ordinary circumstances, including congestion. Backpressure is used instead. Storage networking customers have come to expect extremely low error rates and zero frame drops in Fibre Channel environments. However, to provide minimum bandwidth guarantees in a one-to-many scenario requires frame drops in certain situations. Frame drops are expected in an Asynchronous Transfer Mode (ATM) switch as part of the policing functions of the switch. An ATM switch can provide QoS capabilities similar to The preferred embodiment, but ATM is far more complicated and difficult to administer. In a Preferred embodiment switch in its default modus operandi, if any one call from a port is back-pressured, all of the calls from that port are proportionally back-pressured. One of these calls might be backpressured to the point that the source is not permitted to send frames at the minimum bandwidth specified for a call (policy). The Preferred embodiment Connection Control Engine may be offering the minimum service bandwidth for the call, but the backpressure may inhibit the source from sending at the minimum rate. Technically, the switch is meeting the policy requirement, but the customer will not measure the desired throughput. By default, the Preferred embodiment Connection Control Engine chooses to maintain data integrity and compromise policy, a modus operandi referred to as “Bandwidth Shaping” mode. Other embodiments offer “Bandwidth Guarantee” mode, where frame drops are permitted in certain well-defined scenarios in which QoS calls would otherwise be unable to meet minimum bandwidth requirements, e.g. because of the inability to extend per-virtual-circuit flow control to the end nodes using Fibre Channel Class 2 or Class 3 classes of service.

At a high level, the switching architecture is a virtual output queued (VOQed) crossbar architecture. The VOQs, at the ingress, and the output queues, at the egress, of each port on the switch may communicate with the scheduling/arbitration engine(s) out of band, i.e. not using the same communication paths as the network traffic, so as to not detract from the bandwidth available to the network traffic. The queue-to-scheduling/arbitration engine communication is feedback, whereby the scheduling/arbitration engine may make use of statistics describing the current status of the queues in making scheduling/arbitration decisions.

The VOQs can be pre-assigned to specific egresses, or dynamically assigned as needed. In a preferred embodiment, at each ingress, one VOQ is pre-assigned to each egress within the switching device, and additional VOQs may be assigned as needed. Additional VOQs are needed in order to differentiate flows that share a path from an ingress to an egress within the switching device. VOQs can be established manually by an administrator, or automatically by a classification engine at the ingress that searches certain fields in incoming frames to distinguish features such as destination address, source address, destination protocol port (e.g. TCP port), source protocol port, destination logical unit number (LUN), exchange number, VLAN tag, MPLS label, or any of a host of other possible fields. Maximum VOQ depths are defined, but the physical memory need not be dedicated to the particular VOQ until needed, which greatly improves the efficiency of ingress memory system utilization, reducing the total amount of ingress memory required in the design.

In a preferred embodiment, the ingress memory system design couples the Fibre Channel flow control buffer-to-buffer credit (BB credit) memory with this set of dynamic virtual output queues. Any fraction of the ingress physical memory can be associated with the BB credits for the port. However, the BB credit memory is not physically distinct from the VOQ memory. The memory system keeps track of the remaining memory space available in the “free queue.” However, the memory system also keeps track of which specific VOQs have drawn from the BB credit pool, meaning that the memory system is actually assigning more memory to that VOQ than the nominal maximum depth of that VOQ. BB credits that are associated with a particular VOQ exceeding its maximum number of buffers threshold are terms “queue credits.” It is also possible for the free queue to be sufficiently low, below its minimum number of buffers threshold, that BB credits must be decremented even if a VOQ is not exceeding its maximum threshold. These BB credits are termed “port credits.” Distinguishing port and queue credits is useful, e.g. when it is necessary to flush a VOQ and relinquish the correct number of BB credits.

Because of the lack of availability of Fibre Channel Class 4 HBAs, it is preferred that devices that aggregate or proxy for multiple logical or physical entities be endowed with the capabilities of the preferred embodiments of the present invention. Such devices may include certain blade servers, networked appliances, N_Port virtualizing devices, and storage array front ends.

One skilled in the art will appreciate further features and advantages of the invention based on the above-described embodiments. Accordingly, the invention is not to be limited by what has been particularly shown and described. All publications and references cited herein are expressly incorporated herein by reference in their entirety. It is understood that the term preferred embodiment(s) as used herein refers to any embodiment having one or more of the inventive features described herein. The term preferred embodiment should be construed broadly to include various embodiments and combinations of the exemplary embodiments described herein.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims.

All publications and references cited herein are expressly incorporated herein by reference in their entirety.

1. A switching device, comprising:
an ingress media access control module to receive incoming frames;
a classification engine to process frame data from the media access control module based upon at least on attribute;
a queue ingress manager to assign data to one of a plurality of queues based upon the processing by the classification engine, and to update registers, tables, and counters describing memory system status;
a plurality of transmit queues to receive data from the queue ingress manager;
a metadata generator coupled to the plurality of queues to encapsulate the data from the transmit queues as the data is transmitted out of the queues;
a switch fabric to receive the encapsulated data;
a queue egress manager coupled to the plurality of transmit queues to manage transmission of frame data from the plurality of transit queues to the switching fabric, and to update registers, tables, and counters describing the memory system status;
a metadata stripper coupled to the switch fabric to strip the encapsulation data;
a receive memory system to store the un-encapsulated data; and
an egress media access control to receive data from the receive memory system.

2. The device according to claim 1, further including a queue flush manager to flush a selected one of the plurality of transmit queues, and to update registers, tables, and counters describing the memory system status.

3. The device according to claim 1, wherein the plurality of transmit queues differentiate data flows through the device.

4. The device according to claim 1, where an administrative user interface enables an administrator to establish policy groups of switch ports, and to establish QoS policies between pairs of policy groups.

5. The device according to claim 4, wherein the QoS policies includes at least one of minimum bandwidth guarantee through the device, a maximum bandwidth, distributing excess bandwidth according to need, distributed excess bandwidth fairly when egress is congested, bounded jitter, and release of unused minimum bandwidth.

6. The device according to claim 1, wherein a centralized scheduling/arbitration engine upholds policies established through the administrative user interface.

7. The device according to claim 1, wherein a centralized scheduling/arbitration engine upholds minimum bandwidth policies, by reserving sufficient time slices per epoch for the ports in the associated policy groups.

8. The device according to claim 1, wherein the device provides QoS through the device for data in a connectionless format.

9. The device according to claim 8, wherein the connectionless format is selected from one or more of Ethernet, Fibre Channel class 2 and Fibre Channel class 3.

10. The device according to claim 1, wherein the encapsulated data includes metadata for at least one of global source address, local source port ID, source queue ID, global destination address, local destination port ID, destination queue ID, underlying protocol ID, application ID, flow ID, frame drop classification, and priority.

11. The device according to claim 1, wherein the plurality of transmit queues include virtual output queues.

12. The device according to claim 1, wherein the device includes a virtual output queued scheduled crossbar switched architecture using slotted time division multiplexing.

13. The device according to claim 1, further including parameter and/or statistic feedback for use by the queue ingress manager.

14. The device according to claim 13, further including ingress and egress feedback for processing by a scheduling/arbitration engine to optimize bandwidth allocation based upon usage and congestion.

15. The device according to claim 14, further including a mechanism to send scheduler allocation messages to ports to inform the ports as to which of the plurality of queues should transmit during a given time slice.

16. The device according to claim 1, further including a plurality of ports each of which is assigned to one of a plurality of policy groups.

17. The device according to claim 1, wherein a connection is assigned a minimum bandwidth and a maximum bandwidth.

18. The device according to claim 1, further including scheduling bandwidth on an epoch basis.

19. The device according to claim 1, further including a connection control engine to emulate at least one feature of a Fibre Channel Class 4 device.

20. The device according to claim 1, further including a further switching device supporting QoS policies for connectionless data flows coupled to the switching device to provide end-to-end QoS guarantees from the switching device to the further switching device.

21. A switching device, comprising:
a switching fabric; and
a processing means coupled to the switching fabric, the processing means to enable meeting QoS requirements for data in a connectionless format.

22. The device according to claim 21, wherein the connectionless format includes one or more of Ethernet, Fibre Channel Class 2 and Fibre Channel class 3.

23. The device according to claim 21, wherein the QoS requirements includes at least one of minimum bandwidth guarantee through the device, a maximum bandwidth, distributing excess bandwidth according to need, distributed excess bandwidth fairly when egress is congested, bounded jitter, and release of unused minimum bandwidth.

24. The device according to claim 21, wherein the processing means includes a metadata generator means to encapsulate the data prior to transmission to the switching fabric.

25. The device according to claim 24, wherein the processing means includes a plurality of transmit queues.

26. The device according to claim 25, wherein the processing means includes a transmit queue ingress manager coupled to the plurality of transmit queues.

27. The device according to claim 26, wherein the processing means includes a transmit queue egress manager coupled to the transmit queues.

28. The device according to claim 27, wherein the processing means further includes a metadata stripper.

29. The device according to claim 28, wherein the processing means further includes a queue flush manager to flush a selected one of the plurality of queues.

30. The device according to claim 21, wherein the processing means is provided on a line card.

31. The device according to claim 25, a control means to enable a centralized scheduler/arbitration engine to communicate to ports which of the plurality of queues is permitted to transmit into the switching fabric.

32-44. (canceled)

45. A method comprising:
receiving data at a first port within a network switching device;
queuing the received data into a plurality of queues;
causing data to be output from specific ones of the queues, based on a set of QoS criteria and time dependent attributes of the plurality of queues;
associating the data output from the queues with QoS related metadata; and
transmitting the data output from the queues and the associated metadata into a switching fabric within the network switching device, for transmission to a second port within the network switching device.

46. A method as recited in claim 45, further comprising:
transmitting the data from the second port to a device which is external to the network switching device.

47. A method as recited in claim 46, further comprising, in the second port, prior to transmitting the data from the second port to the device which is external to the network switching device:
removing the metadata from the data transmitted through the switching fabric to the second port.

48. A method as recited in claim 45, wherein associating data output from the queues with metadata comprises encapsulating data output from the queues with metadata.

49. A method as recited in claim 45, further comprising:
providing feedback to the scheduling/arbitration engine regarding time-dependent attributes of the plurality of queues, wherein said operating the flow control mechanism is based on the feedback.

50. A method as recited in claim 45, wherein the method is performed within a storage server.

51. A method as recited in claim 45, wherein the data received at the first port is in a connectionless format.

52. A method as recited in claim 45, further comprising:
dynamically allocating memory to the queues on an as-needed basis.
